(19) United States
(12) Patent Application Publication
(10) Pub. No.: US 2024/0390928 A1
(43) Pub. Date: Nov. 28, 2024

(54) SUPERSONIC ATOMISER

(71) Applicant: Element 6 GmbH, Graz (AT)

(72) Inventor: Hans-Jörg FÜRPAß, Graz (AT)

(21) Appl. No.: 18/686,477

(22) PCT Filed: Apr. 21, 2022
(86) PCT No.: PCT/AT2022/060125

§ 371 Date: Feb. 26, 2024

(30) Foreign Application Priority Data
Nov. 5, 2021 (AT) A 50878/2021

(51) Int. Cl. B05B 17/06

(52) U.S. Cl. CPC B05B 17/06

(57) ABSTRACT

Provided herein is a supersonic atomizer and a method for atomizing a liquid into fine droplets, in particular for homogenizing the liquid. The atomizer may include a central axis, an inner part with a liquid channel extending along the central axis and leading into a liquid-outlet opening, and an outer part with a gas channel leading into a gas-outlet opening. The gas channel may have a de Laval gap, running annularly around the central axis, for accelerating the gas to supersonic speed upstream of the gas-outlet opening.

### CROSS-REFERENCE TO RELATED APPLICATIONS

This application is a national stage application filed under 35 U.S.C. § 371 of International Application No. PCT/AT2022/060125 filed Apr. 21, 2022, which application is hereby incorporated by reference in its entirety.

### FIELD OF TECHNOLOGY

Various embodiments of the present disclosure relate to an atomizer for the atomizing of a liquid into fine droplets. The atomizer may be used for the homogenizing of the liquid. In an example embodiment, the atomizer includes a central axis, an inner part with a liquid channel extending along the central axis and leading to a liquid outlet opening, and an outer part with a gas channel, which leads to a gas outlet opening.

The present disclosure further relates to a process for the atomizing of a liquid into fine droplets to homogenize the liquid. The method may include the steps of leading the liquid through a liquid channel of an inner part to a liquid outlet opening, and leading a gas through a gas channel of an outer part to a gas outlet opening.

### BACKGROUND

A spray nozzle is known from DE 19632642A1, in which a liquid is guided along two liquid flow surfaces. Ultrasonic gas jets are aimed at the liquid flow surfaces. The gas flow separates the liquid as a thin film, which flows to the edge. The thin film flow becomes thinner, separates from the edge and is sprayed in the form of fluid droplets. The fluid droplets are drawn into the gas jet convergence point, where they are further split up into fine particles by shockwaves from the gas jets. The fine particles are quickly pulled away from the edge by the flow of gas. However, the complicated structure of this spray nozzle, and its associated high production effort, is a drawback. In addition a separation tip for the liquid is provided for in this prior art. The atomization takes place at the gas jet convergence point through impingement with the gas jets from two sides. Furthermore, this spray nozzle can only be used under limited operating and environmental conditions. Finally, the narrow liquid channels are poorly suited to liquids containing solids.

In addition to this, there are various processes known in the prior art for the preparation of emulsions.

For this, rotating instruments, such as dispersion disks or rotor-stator systems can be used, which transmit strong shear forces to the fluid and achieve a division and distribution of the disperse phases. However, the droplet sizes achieved are limited to a few micrometers. In addition, the intensity and duration of the stirring are critical to temperature input. These processes are therefore suitable for continuous operation only to a limited extent.

For the preparation of nano-emulsions in the pharmaceutical field, high pressure homogenizers are primarily used, a combination of a high pressure pump and a special valve. The sudden reduction of several hundred bars of excess pressure causes fragmentation into droplets in the nanometer range. Shear forces on the product are considerable. Moreover, throughput performance, achieved quality and process management are highly dependent on target specifications and whether a pre-emulsion has already been prepared.

Droplet-based microfluidics represent a novel and expandable technology. Droplets are formed at an intersection of two immiscible fluids (a T-junction). Multiple factors, such as geometry, flow velocity or fluid characteristics can affect droplet sizes. This involves a continuous and largely reproducible process for the preparation of nano-emulsions.

Membrane and extruder technologies are primarily used in filtration. The disperse phase is pressed through a substrate with nano-pores, and mixes with the continuous phase. The advantage of the process is a very uniform distribution in the emulsion with the smallest droplet sizes and moderate pressure. The membrane surfaces limit the throughput, which is reflected in investment costs. In addition, cleaning is very costly.

In ultrasonic systems, a generator produces ultrasonic vibrations, which are introduced into the liquid through a transmission unit (sonotrode). This leads to cavitation effects and through this to the fragmentation of droplets. This complex process can, depending on the characteristics of the two-phase mixture, generate droplet sizes of a few micrometers. However, its use is only meaningfully possible in the laboratory, due issues with scalability and high specific energy input.

### BRIEF SUMMARY

In contrast, the object of this invention is to alleviate or eliminate at least some of the drawbacks of the prior art. The preferred aim of the invention is to make possible atomization of a fluid in a simple, reliable manner with a compact apparatus.

This issue is solved with an atomizer (e.g., a supersonic atomizer) according to various embodiments disclosed herein. Preferred embodiments are specified in the dependent claims.

For example, the atomizer may include a gas channel with a de Laval gap running annularly around the central axis, which is arranged so as to accelerate the gas to supersonic speed (viewed in the direction of flow of the gas) upstream from the gas outlet opening.

The process for the atomizing of a liquid into fine droplets may include acceleration of the gas to a supersonic speed using a de Laval gap running annularly around the central axis within the gas channel.

For the purposes of this disclosure, location and direction information, such as “inner,” “outer,” “radial,” “axial,” “running . . . around,” are in reference to the central axis of the atomizer. Furthermore, information, such as “before,” “behind,” “upstream” and “downstream,” refer to the direction of flow of the gas or the liquid.

With embodiments of the present atomizer, the gas acts as an atomizing means at the gas outlet opening, by which the liquid is dispersed into fine droplets of preferably less than 10 micrometers, downstream from the liquid outlet opening. For this purpose, the gas is accelerated using the de Laval gap by the gas pressure to supersonic speed. To form the de Laval gap, the cross section of the gas channel first narrows and then widens, with the steady transition from the tapering cross section through the de Laval gap to the widening cross section. In the prior art, only different de Laval nozzles with circular or elliptical cross sections are known. In contrast the atomizer according to the invention comprises an annular, in particular a circular annular de Laval gap, which is preferably symmetrically disposed around the central axis. In this way, the liquid channel can extend in an axial direction along the central axis. The liquid channel preferably has a cylindrical liquid outlet section (or one tapering towards the front), the central axis of which substantially coincides with the central axis of the atomizer. Shockwaves are generated by the acceleration of the gas in the de Laval gap, which, downstream from the gas opening outlet, carries along the liquid and atomizes it with particular effectiveness.

This embodiment brings with it a range of advantages. No further measures or energy sources are needed for the generation of fine droplets apart from the gaseous atomizing medium and a moderate feed pressure of the liquid. Due to the direct input of energy, the liquid particles can be conditioned using steam, air or nitrogen as a gaseous atomizing medium. Depending on the application, even the additional effect of a sterilization can be achieved over the contact time. Due to the compact structure of the atomizer, and flexible connection options, retrofitting to existing systems are made possible. Appropriate gases are available in most process plants. Since the atomizer preferably has no moving parts, wear and tear are minimal.

The liquid channel extends preferably in a straight line between a liquid supply opening and the liquid outlet opening. In this way cleaning requirements in pharmaceutical applications can be better fulfilled. In particular, when the liquid channel is free from built-in components, even suspensions can be introduced into the liquid channel. When mentioning a “liquid” in the liquid channel, this should of course also included suspensions.

In one embodiment variant, the central axis of the atomizer is disposed during use substantially vertically. This variant has the advantage that the atomizer can self drain after use, since the liquid can flow out by means of gravity. In a further variant, the central axis of the atomizer is disposed during use substantially at an angle of less than 90° to the horizontal, or substantially horizontally.

The gas outlet opening is preferably annular in shape and disposed at a radial distance from the central axis. Moreover, the atomizer preferably has a gas supply opening for the supply of the gas into the gas channel. The gas channel can be attached to a gas supply section connecting to the gas supply opening, where said section is formed in particular on a gas supply part differing from the outside part. The gas supply section extends preferably at an angle, in particular substantially at a right angle, to the central axis. On the gas supply section an in particular annularly shaped gas guide section can be connected in the direction of the central axis (as always, viewed in the direction of gas flow), which can merge into a gas outlet section leading into the gas outlet opening. The gas guide section and/or the gas outlet section of the gas channel preferably extend between the outside of the inner part and the inside of the outer part.

The annular-shaped (i.e. running 360° around) de Laval gap at the narrowest part preferably has a width (i.e. an extension perpendicular to the direction of flow of the gas) of 0.1 millimeter (mm) to 1 mm, in particular from 0.2 mm to 0.4 mm.

In a preferred embodiment the width of the de Laval gap can be adjusted with an adjustment element, for example from 0.2 mm to 0.4 mm.

In another preferred embodiment, the gas channel has a gas outlet section running at an angle towards the outside and leading to the gas outlet opening. Surprisingly, with this design, a particularly effective atomization of the liquid jet is achieved.

In some embodiments, the gas outlet section has an outlet cone with an aperture angle from 90° to 120°. In some other embodiments, the gas outlet section has an outlet cone with an aperture angle from 100° to 150°. The outlet cone is formed through a conical boundary surface of the outer part, the center axis of which preferably coincides with the central axis [of the atomizer]. The gas is pushed out through the gas outlet opening, accelerated to a supersonic velocity and in the form of a hollow cone.

In order to bring the liquid jet into contact with the gaseous atomizing medium, it is beneficial when the inner part has a liquid guide surface around the liquid outlet opening, which is surrounded by the gas outlet opening. In this way the liquid guide surface extends between the inner liquid outlet opening and the outer gas outlet opening, for the formation of the liquid film. In operation, the liquid flows outwards under the effect of the gas along the liquid guide surface, i.e. away from the central axis, until the liquid is captured by the gas jet and is atomized.

For an effective atomization of the liquid it is beneficial if a separation edge for the liquid is formed radially on the outer edge of the liquid guide surface. In this way, the liquid, flowing radially outwards over the liquid guide surface, is carried away by the gas jet at the separation edge. The separation edge is preferably circular. The liquid is preferably released into the surroundings as a free jet at the separation edge of the liquid guide surface.

In a first embodiment variant, a substantially flat liquid guide surface is provided, which preferably extends perpendicularly to the central axis. Viewed in the direction of the central axis, the substantially flat liquid guide surface is preferably substantially annular in shape.

A second embodiment variant, provides for a liquid guide surface, protruding forward over the gas outlet opening, and in particular convexly curved. This embodiment variant in particular has the advantage that the extension of the liquid guide surface is enlarged for the formation of the liquid film.

For the formation of the de Laval gap, the outer part preferably has an inward protrusion and/or the inner part has an outward protrusion. Preferably, the inward facing protrusion is arranged to run annularly around the outer part, or the outward facing protrusion to run annularly around the inner part.

In one preferred embodiment, the ratio between the inner diameter of the protrusion (i.e. the shortest distance between two sections of the inward protrusion, that are 180° opposite of each other) and the diameter of the liquid guide surface is from 1.0 to 1.2, in particular from 1 to 1.1. In another embodiment, the ratio may be from 0.95 to 1.2.

In a first embodiment variant the de Laval gap is arranged at the free end, i.e. at the turning point, of the inward protrusion. This embodiment has the particular advantage that the inner part can be centered in relation to the outer part with particular ease, so as to form the de Laval gap evenly over the circumference.

In a second embodiment variant, the de Laval gap is arranged inwards on a (front) outlet side of the protrusion. With this embodiment, the de Laval gap is disposed inwards farther in front of the turning point of the protrusion. This embodiment is characterized by a particularly fine solution.

In a third embodiment variant, the de Laval nozzle is arranged inwards on a (rear) inlet side of the protrusion. With this embodiment, the gas jet can be reflected to the inner part before the gas jet is guided by the outlet section to the gas outlet opening. A further advantage is that the inner part can be removed from the outer part towards the rear, i.e. away from the gas outlet opening.

Depending on the application, the excess pressure of the gas upstream from the de Laval gap (under standard environmental conditions of 293.15 K and 1 atm, and a gas temperature of 293.15 K) is from 1.25 bar/o (bars over atmospheric pressure) to 4 bar/o, in particular from 1.5 bar/o to 2.5 bar/o. The excess pressure of the liquid versus atmospheric pressure at the liquid inlet opening can be from 0.1 bar to 1 bar, in particular from 0.2 to 0.5 bar. In particular, air, steam, nitrogen or a noble gas can be used a gas.

In a preferred application of the process, the liquid has at least two (or more, miscible or immiscible) phases (with or without containing solids), such as oil or water. The liquid is separated into droplets by shockwaves and is caught in a suitable container. An advantageous characteristic of the liquid mixture or emulsion collected is that it is very homogeneous, due to this fine atomization, even distribution and thorough mixing. Furthermore, this enables continuous operation.

The invention is further explained below, according to preferred embodiment examples.

### BRIEF DESCRIPTION OF THE DRAWINGS

Having thus described some embodiments in general terms, reference will now be made to the accompanying drawings, which are not necessarily drawn to scale, and wherein:

FIG. 1 shows a profile view of a first embodiment of an atomizer according to the invention.

FIG. 2 shows Detail A, highlighted in FIG. 1.

FIG. 3 shows a cross section of the atomizer, along the line III-III, in FIG. 1.

FIG. 4 shows a profile view of a second embodiment of the atomizer according to the invention.

FIG. 5 shows Detail B, highlighted in FIG. 4.

FIG. 6 shows a cross section of the atomizer along the line VI-VI, in FIG. 4

FIG. 7 shows a profile view of a third embodiment of the atomizer according to the invention.

FIG. 8 shows Detail C, highlighted in FIG. 7.

FIG. 9 shows a cross section of the atomizer along the line IX-IX, in FIG. 7

FIG. 10 shows a further embodiment of the front area of the atomizer, with a liquid guide surface convexly curved outwards.

### DETAILED DESCRIPTION

Embodiments now will be described more fully hereinafter with reference to the accompanying drawings, in which some, but not all embodiments are shown. Indeed, embodiments of the invention may be implemented in many different forms and should not be construed as limited to the embodiments set forth herein; rather, these embodiments are provided so that this disclosure will satisfy applicable legal requirements. Like numbers refer to like elements throughout.

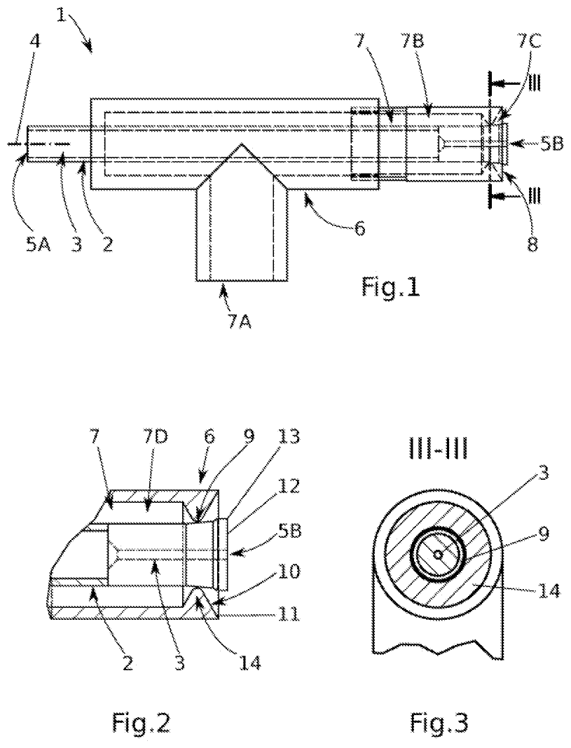

FIG. 1 shows a profile view of an atomizer 1, with which a liquid can be atomized, i.e. broken down into fine droplets. The atomizer 1 is particularly suitable for the homogenizing of a multi-phase liquid.

Example embodiments of the atomizer 1 comprises an inner part 2 with a liquid channel 3, which extends in the direction of a central axis 4 of inner part 2. Liquid channel 3 comprises a liquid supply opening 5A on the rear end (viewed from the direction of flow of the liquid) of inner part 2, and a liquid outlet opening 5B on the front end of inner part 2. The liquid from liquid channel 3 is emitted outwards through liquid outlet opening 5B. The depicted atomizer 1 further comprises a sleeve-shaped outer part 6, which accommodates inner part 2 within. Outer part 6 comprises a gas channel 7 for a gaseous atomizing medium, abbreviated below as the “gas”. As an example, nitrogen, air, steam or a noble gas can be provided as this gas. A gas supply part comprises a gas supply section 7A, which is disposed at a right angle to central axis 4. Outer part 6 has a gas guide section 7B, connecting to gas supply section 7A, parallel to central axis 4, and a gas outlet section 7C (described in more detail below), which (viewed in the direction of flow of the gas) leads into a gas outlet opening 8 on the front end of outer part 6, through which the gas from gas channel 7 is emitted outwards.

In the embodiment shown, gas channel 7 comprises a de Laval nozzle in the form of a de Laval gap 9 running annularly around the central axis, with which, before reaching gas outlet opening 8, gas is accelerated to supersonic speed, so that an unexpanded gas jet is generated in gas outlet opening 8. This causes a subsequent expansion of the gas in gas outlet opening 8. Gas outlet section 7C is at an angle to central axis 4. Gas outlet section 7C comprises an outlet cone 10 with an aperture angle from 90° to 120°, based on a conical boundary surface 11 of outlet cone 10. In the presented embodiment, the aperture angle is approximately 120°. Inner part 2 comprises a liquid guide surface 12 on the front end (viewed in the direction of flow of the liquid), which restricts liquid outlet opening 5B (in this case circular) on the inside, and is surrounded by gas outlet opening 8 on the outside. On the radial outer edge of liquid guide surface 12, a separation edge 13 is formed for the liquid. A flat liquid guide surface 12 is provided in the embodiment shown, which extends in a substantially perpendicular direction and is substantially symmetrical around central axis 4. In the embodiment variant from FIG. 13, liquid guide surface 12 is convexly curved (i.e. towards the front). In this way the surface area of liquid guide surface 12 is enlarged.

In the embodiment variant from FIGS. 1 through 3, outer part 6 comprises an protrusion 14 projecting inwards with an inwardly curved (free) end. The extension of protrusion 14 inwards (viewed in the direction of flow of the gas) diminishes inwards. Inner part 2 expands in the direction of flow of the gas to gas outlet opening 8. With this embodiment variant, de Laval gap 9 is provided inwards on the free end, i.e. at the turning point, of protrusion 14.

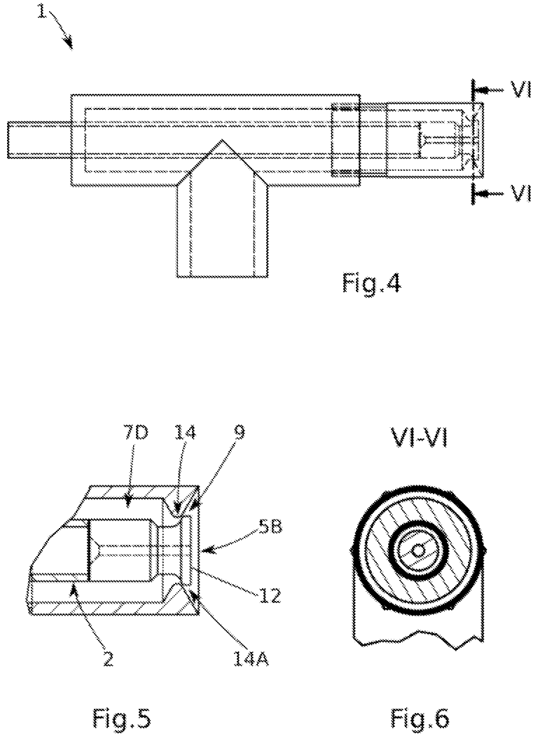

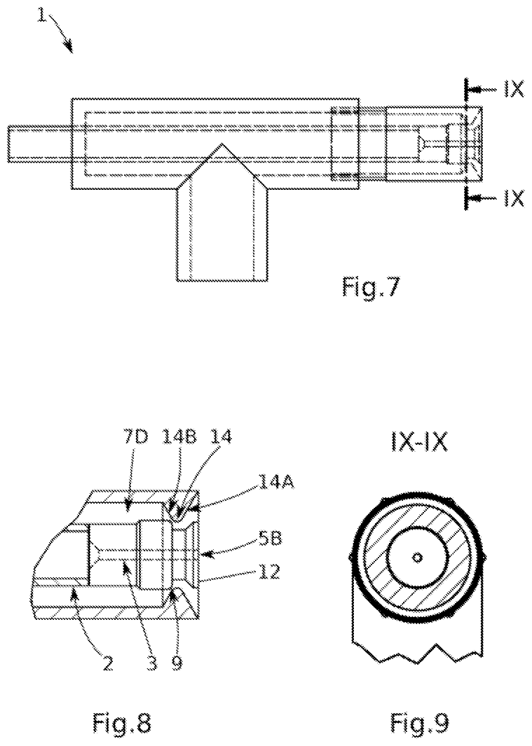

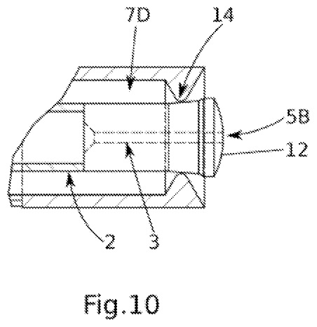

In the embodiment variant from FIGS. 4 through 6, outer part 6 likewise comprises inward projecting protrusion 14 on outer part 6 for the formation of de Laval gap 9. Inner part 2 is shaped and disposed in relation to outer part 6 so that de Laval gap 9 is formed inwards on a front outlet side 14A (not shown in the drawings) of protrusion 14. In the embodiment variant in FIGS. 7 through 9, inner part 2 is shaped and disposed relative to outer part 6 so that de Laval gap 9 is formed inwards on a rear-facing inlet side 14B of protrusion 14.

The following process can be performed with the atomizer 1 for atomizing a liquid into droplets, in particular for the homogenizing of multiple phases of the liquid:
leading the liquid through the liquid channel of inner part 2 to liquid outlet opening 5B;
leading the gas through the gas channel of outer part 6 to gas outlet opening 8;
acceleration of the gas to supersonic speed by means of de Laval gap 9, inside of the gas channel, running annularly around the central axis; and
atomizing the liquid after passing through the liquid outlet opening with the gas accelerated to supersonic speed.

Many modifications and other embodiments will come to mind to one skilled in the art to which these embodiments pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the appended claims. Although specific terms are employed herein, they are used in a generic and descriptive sense only and not for purposes of limitation.

1. An atomizer for atomizing a liquid into fine droplets for homogenizing the liquid comprising:
a central axis;
an inner part with a liquid channel extending along the central axis, which leads a liquid outlet opening;
an outer part with a gas channel, which leads into a gas outlet opening,
wherein
the gas channel comprises a de Laval gap running annularly around the central axis for acceleration of the gas to supersonic speed upstream from the gas outlet opening.

2. The atomizer according to claim 1, wherein the gas channel comprises a gas outlet section running at an angle outwards, leading into the gas outlet opening.

3. The atomizer according to claim 2, wherein gas outlet section comprises an outlet cone with an aperture angle of 90° to 120°.

4. The atomizer according to claim 1, wherein the inner part comprises a liquid guide surface around the liquid outlet opening, which is surrounded by the gas outlet opening.

5. The atomizer according to claim 4, wherein a separation edge for the liquid is formed on the radial outer edge of the liquid guide surface.

6. The atomizer according to claim 5, wherein a substantially flat liquid guide surface is provided, which extends in a substantially perpendicular direction to the central axis.

7. The atomizer according to claim 5, wherein a convexly curved liquid guide surface protruding forward is provided over the gas outlet opening.

8. The atomizer according to claim 1, wherein the outer part comprises an inward protrusion for the formation of the de Laval gap.

9. The atomizer according to claim 8, wherein the de Laval gap is arranged on the free end of the inward protrusion.

10. The atomizer according to claim 8, wherein the de Laval gap is arranged on an outlet side of the inward protrusion.

11. The atomizer according to claim 8, wherein the de Laval gap is arranged on an inlet side of the inward protrusion.

12. A process for the atomizing of a liquid into fine droplets for homogenizing the liquid, the method comprising:
leading the liquid through a liquid channel of an inner part to a liquid outlet opening;
leading a gas through a gas channel of an outer part to a gas outlet opening; and
accelerating the gas to supersonic speed via a de Laval gap running annularly around the central axis within the gas channel.
